(19) United States
(12) Patent Application Publication
(10) Pub. No.: US 2019/0217867 A1
(43) Pub. Date: Jul. 18, 2019

(54) METHOD FOR OPERATING AN ELECTRICAL SYSTEM OF A MOTOR VEHICLE

(71) Applicant: Robert Bosch GmbH, Stuttgart (DE)

(72) Inventors: Juergen Barthlott, Kuernbach (DE); Oliver Dieter Koller, Weinstadt (DE); Christian Bohne, Stuttgart (DE); Patrick Muenzing, Fellbach (DE); Armin Ruehle, Weinstadt (DE); Hans-Peter Seebich, Budapest (HU); Tuelin Baysal, Tamm (DE)

(21) Appl. No.: 16/336,404

(22) PCT Filed: Sep. 8, 2017
(86) PCT No.: PCT/EP2017/072541

§ 371 Date: Mar. 25, 2019

(30) Foreign Application Priority Data
Sep. 27, 2016 (DE) 102016218555.1

(51) Int. Cl. B60W 50/00; B60W 40/12

(52) U.S. Cl. CPC B60W 50/0097; B60W 40/12

(57) ABSTRACT

A method for operating an electrical system of a motor vehicle, the vehicle electrical system including a plurality of components, a prediction of a future state of at least one component in the form of a state analysis being made from values regarding a loading capacity of the at least one component, a decision being made about enabling at least one driving function of the motor vehicle as a function of a result of the state analyses carried out, the driving function being supported by the at least one component of the vehicle electrical system.

### FIELD OF THE INVENTION

The present invention relates to a method and a set-up for operating an electrical system of a motor vehicle.

### BACKGROUND INFORMATION

An electrical system of a motor vehicle has the task of supplying power to electrical load circuits. If a power supply fails due to a fault or ageing of at least one component of the vehicle electrical system, then important functions, such as power steering, are lost. Since the steering of the motor vehicle is not impaired, but only becomes stiff, the failure of the electrical system is generally accepted in motor vehicles mass-produced today.

Due to increasing electrification of units, as well as the introduction of new driving functions, higher standards for safety and reliability of the supply of electricity in the motor vehicle result.

In the case of a future, highly-automated driving function, such as a highway pilot, the driver is permitted non-driving activities to a limited extent. The result of this is that the human driver may only perceive the function as a sensory, control-engineering, mechanical and energetic fallback level in a limited manner up to the termination of the highly automated driving function. Therefore, for ensuring the sensory, control-engineering and actuator fallback level during highly automated driving, the supply of electric power has, in the motor vehicle, a relevance to safety not known up to this point. Thus, faults or ageing in the vehicle electrical system must be detected reliably and as completely as possible in accordance with product safety. In this connection, it must be taken into account that in the case of fully automatic or autonomous driving, the driver is eliminated completely as a fallback level described above.

Two-channel vehicle electrical systems are described, inter alia, in printed publication WO 2015/135729 A1 or in printed publication DE 10 2011 011 800 A1.

Approaches for monitoring a technical reliability of components of an electrical system of a motor vehicle are provided, in order to be able to predict a failure of components in a part of an electrical system. In this context, the components are monitored during operation, and damage to them is determined, which is described in printed publication DE 10 2013 203 661 A1.

A monitoring set-up for monitoring an electrical system of a motor vehicle is known from printed publication DE 10 2013 201 060 A1. The vehicle electrical system includes a high-voltage electrical system and a low-voltage electrical system, which are interconnected via a d.c. voltage converter; several load circuits critical with regard to safety being connected to the low-voltage electrical system. The monitoring set-up includes a monitoring control unit and, as further components for each load circuit critical with regard to safety, an assigned sensor for measuring a value of an electrical operating parameter of the load circuit; the monitoring control unit being configured to monitor at least one load circuit in view of the measured value of the electrical operating parameter.

### SUMMARY

Against this background, a method and a set-up are put forward.

For an electrical system of a motor vehicle, a monitoring unit is used for all of the components of the vehicle electrical system during the execution of the method; all of the components being preventatively monitored by the monitoring unit with regard to their current and possible future state, e.g., in view of wear and/or ageing. A prediction of the future state may be based on these two aspects, that is, the wear and the ageing. However, as an alternative, or in addition, other aspects may also be taken into account. In this context, powernet condition management (PCM) or monitoring of a current state and a prediction of the wear of components of the vehicle electrical system is carried out by the monitoring unit as a component of the set-up put forward; the state of the vehicle electrical system being monitored on a system level of the vehicle electrical system, but also on a component level for each component, using the monitoring unit. In this context, such a monitoring unit is provided for the system level. It is possible to make a prediction on the component level for each individual component, as well as a prediction on the system level for the entire vehicle electrical system; a prediction on the component level being able to be checked for plausibility, using a prediction on the system level.

The monitoring unit includes a diagnostic module and a prediction module as modules. Using the diagnostic module, a diagnosis of an actual state may be made for each component as a possible state analysis. In addition, a diagnosis of an actual state and, therefore, of the current state in the form of a possible state analysis may also be made for the entire vehicle electrical system, normally, in comprehensive view of all of the components of the vehicle electrical system. Using the prediction module, a prediction of a future state may be made for each component as a possible state analysis. In addition, a prediction of a future state in the form of a possible state analysis may also be made for the entire vehicle electrical system, normally, in comprehensive view of all of the components of the vehicle electrical system.

Using this monitoring unit, as a rule, it is automatically decided if a driving function, e.g., an automated driving function, may be enabled or must be prevented, in view of at least one diagnosis and/or prediction for at least one component and/or at least one electrical system channel and/or the entire vehicle electrical system. The monitoring unit, which monitors the components of the vehicle electrical system in an integrated and comprehensive manner, is provided for this; an overall state of the power supply, which is a function of at least one physical operating variable, being assessed by the vehicle electrical system with the aid of the monitoring unit, since individual components of the vehicle electrical system are generally unable to assess this for lack of information about the entire electrical system. As a rule, the driving function is supported by at least one component of the vehicle electrical system.

During execution of the method, individual components of the electrical system transmit current values of at least one, as a rule, physical operating variable, such as current, voltage or temperature, to the monitoring unit. The current state of the vehicle electrical system is monitored in light of values of at least one operating variable, by bringing together a diagnosis of individual components, as well as of the entire electrical system; the diagnosis of the vehicle electrical system on the system level being used for checking the plausibility of the diagnosis of individual components on the component level. In addition, an analysis of a reliability of the entire electrical system, as well as of individual components of the electrical system, may be carried out by the monitoring unit. In this connection, critical states of the power supply are predicted as a function of a topology of the vehicle electrical system, as a function of causes of failure and/or as a function of an operating mode, which is set, for example, to carry out a specific operation of the motor vehicle. In this context, values of the at least one operating variable are measured and monitored in real time, with the aid of which a loading of the at least one component is ascertained on the basis of state and reliability monitoring. In addition, values of an analysis of the state of individual components, which may also include failure probabilities, are transmitted to the monitoring unit and used for an analysis of the state of the entire vehicle electrical system.

Using the method and the set-up, it is possible to monitor a state of the electrical system of a motor vehicle and, in so doing, to predict and/or diagnose it.

Using the set-up, the state of all relevant components of the motor vehicle may be monitored in its entirety (status monitoring). In this context, from the point of view of product safety, the set-up is suited to new applications critical with regard to safety, which relate to, e.g., automated driving. In this connection, it is possible, inter alia, for failures due to wear to be identified preventatively as faults of components, which are normally a cause of faulty states of the electrical system in the motor vehicle and are related to safety in the context of new fields of application. In addition, countermeasures for eliminating such faults may be introduced. This relates to, inter alia, progressive ageing or a progressive ageing mechanism of such a component.

In order to assess, in each instance, how critical this ageing is, a significance of the component in the entire electrical system and/or motor vehicle is taken into account with the aid of an algorithm.

In one embodiment, a decision about enabling the, e.g., automated driving function is supported as a function of a result, which the monitoring of at least one component of the vehicle electrical system delivers. In this connection, ageing effects of at least one component in the vehicle electrical system, which are important for at least such a driving function, are taken into account. The enabling of the driving function may be prevented and/or withdrawn as a function of ageing, as a possible state of such a component. If the driving function is currently being carried out and a safety-related state of the at least one component is detected, the driving function may have to be ended and exited. This also relates to, e.g., coasting as an operating mode of the motor vehicle for executing an automated driving function of the motor vehicle and/or as an automated driving function of the motor vehicle, through which functions of the motor vehicle critical with regard to safety are, in turn, preventable.

In one embodiment, preventive driving strategies are used, by which driving situations that result in considerable ageing of the at least one component of the vehicle electrical system are prevented, which means that a reliability of the electrical system is increased.

The method also includes execution of at least one preventive maintenance step for the at least one component, which may be carried out, e.g., at a regular service interval, thereby increasing an availability of the at least one component. By providing early warning of an imminent critical state of the vehicle electrical system, normally, during execution of a driving function, e.g., during automated vehicle operation, a change and/or a surrender of control of the motor vehicle to a driving function in manual vehicle operation easier for the driver to master, may be carried out.

Within the scope of the method, it is also possible to bring the motor vehicle out of automated vehicle operation into a safe state automatically and without intervention of the driver, even in the event of failure of components of the vehicle electrical system, and therefore, to take a necessary safety measure. This also relates to the measure of preventing the enabling of the driving function, should a critical state be predicted by the monitoring unit for the vehicle electrical system, e.g., due to wear of the at least one component of the vehicle electrical system having high importance for the motor vehicle. Therefore, an early warning of the critical state may be issued; time savings resulting in response to the introduction of a fallback strategy.

Through early detection of active and/or looming failures as critical states, the reliability and the safety of the motor vehicle may also be increased during manual, unautomated vehicle operation, which means that a stoppage, e.g., in a traffic lane of a highway, may also be prevented.

With the aid of the method, execution of a future, automated, and even autonomous vehicle operation, and therefore, of a corresponding driving function of the motor vehicle, may be controlled and/or supported; it being taken into account that during such vehicle operation, the driver no longer is or has to be available as a sensory, control-engineering, mechanical and energetic fallback level, since the motor vehicle now assumes functions of the driver, such as environmental recognition, trajectory planning and trajectory implementation, which also includes, e.g., steering and braking.

In this context, in one embodiment, it is checked if the vehicle electrical system is in a faultless state and will also be so in the near future. This also means that an automated and/or autonomous driving function is only available to the driver or user, if the monitoring unit verifies that all of the components necessary for this are in order and a necessary supply of power is secured. A possible failure of the power supply of the components is predictable by the monitoring unit;

countermeasures also being taken before an automated driving function is no longer controllable, since automatic functions for environmental recognition, trajectory planning and implementation are no longer available. By using the monitoring unit, the standards for the electrical system of the motor vehicle, which are very high from the viewpoint of product safety, may be ensured.

In one refinement, a loading and/or a loading capacity of components of the vehicle electrical system are ascertained; the loading being ascertained in real time during continuous operation. Loading-capacity models for the components are ascertained in advance, e.g., in trials, for particular boundary conditions. The loading is converted to the boundary conditions of the loading capacity. By comparing the loading and the loading capacity, assertions regarding a current failure probability and the prediction of the failure may be made; this prediction being compared to a maximum permissible failure probability. The loading-capacity models are normally stored in the monitoring unit (PCM) as a function of the component. If failures of at least one component occur during continuous operation, which is prevented by the monitoring unit, then loading-capacity models may be adjusted and/or generated by evaluating several failures of the same, identical components. A future state of the vehicle electrical system is deduced from the loading capacity.

In addition, it is possible to monitor the state of the vehicle electrical system and to transmit a result to a control unit of the motor vehicle; in some instances, safety-related, automated driving functions being able to be prohibited. Regarding enabling or prohibition of automated driving functions, a distinction is made between different operating modes, e.g., recuperation or coasting, since in general, structures, and consequently, different structures, are formed as a function of the operating mode, and consequently, for a specific, automated driving function in the vehicle electrical system; at least one such structure optionally being able to be formed as a redundant structure. During coasting, this may relate to the loss of a generator as a redundancy with respect to a battery. If, e.g., ageing and/or wear is/are identified for a component, then, within the framework of an analysis of importance, at least their relevance to the vehicle electrical system, as a rule, to the entire motor vehicle as a system level, is taken into account. The importance of a component is a function of a topology of the vehicle electrical system, which may be single-channel or multi-channel and may or may not have an additional battery. In this context, the topology of the electrical system installed in the motor vehicle is determined, as a rule, in accordance with its manufacture. During the development of the vehicle electrical system, the structure of the electrical system is analyzed at least once or only once; operating modes and causes of failure optionally being taken into account. The structure is then stored as at least one algorithm in the monitoring unit. In this context, different algorithms may also be taken into account; in each instance, an algorithm for the structure being a function of an operating mode and/or of a cause of failure. Depending on the motor vehicle, different topologies, which may all be monitored within the scope of the described method, may be produced as a function of a class and a functionality of the motor vehicle. In addition, the importance of the component may also be a function of an operating mode of the motor vehicle.

The determination of the state of the vehicle electrical system by the monitoring unit includes a systemic diagnosis as a state analysis, based on the values of the physical performance quantities as input variables, on the basis of which an actual state of the vehicle electrical system is analyzed; and includes a prediction for predicting the future state of the electrical system on the basis of loadings, to which the individual components were subjected during previous operation in the field, from which a possible loading capacity results. In this context, data regarding the loading capacity of the components result from a development of the components and are a function of a type of the components used, an interconnection configuration of the components, as well as of operating parameters of the components, e.g., a capability of dissipating heat. As a rule, a use of a component does not have any influence on the loading capacity. The loading of the component results from its use in the motor vehicle. Characteristic quantities for a reliability of at least one component, e.g., a current failure probability of the component and a prediction of the failure of the component, are ascertained from the loading and the loading capacity. Within the scope of the method, the at least one component is monitored by sensor, and its actual state is diagnosed in light of values of the at least one operating variable. A previous total loading of the at least one component may also be determined from values of these operating parameters, which are ascertained and collected over a relatively long period of time, e.g., during the entire previous operation of the at least one component. A current loading of the at least one component may be ascertained from current values of these operating parameters. Values of the performance quantities are supplied to the monitoring unit by sensors, which are assigned to the components. In this context, the loading is ascertained on the basis of values of the at least one physical operating variable, which resulted previously during operation of the at least one component. is calculated as at least one characteristic reliability quantity of the at least one component, e.g., its failure probability, from performance quantities related to loading and a previous loading, in combination with the loading capacity.

During execution of the method, it is also possible to compare the state of the components of the vehicle electrical system to a central database and, from this, to optionally make decisions as to whether electrical loads are reduced by the switching-off or degradation of load circuits in the form of components of the vehicle electrical system, or whether particular operating modes are prevented, which means that operation of the components of the vehicle electrical system may be optimized. In this connection, it is possible for a state of an electrical system of a first motor vehicle to be compared to states of electrical systems of other motor vehicles; a difference in the state of the motor vehicle due to, e.g., a fault of the at least one component of the vehicle electrical system, and possibly, of the complete electrical system, being able to be identified and eliminated by comparison to states of electrical systems of the other vehicles. Thus, e.g., a fault in one component may lead to excessive loading of another component, which may be detected and eliminated.

In addition, field data may be acquired, which may be taken into account in developing and/or designing future components.

In one refinement of the set-up, physical and/or systemic diagnoses of the individual components are brought together in the monitoring unit and, therefore, at a central location. In this context, it is also possible to implement the method in a software-aided manner, since the monitoring unit has at least one processing unit or is configured as a processing unit for monitoring the components of the vehicle electrical system. In this context, it is conceivable for a driving function to be prohibited, and therefore, not enabled, although a current, actual state of the vehicle electrical system ascertained on the basis of the state analysis taking the form of a diagnosis may indeed be satisfactory, but a future, critical state is predicted on the basis of the state analysis, which is also performed and takes the form of a prediction.

Possible faults and/or possible ageing of components of the vehicle electrical system is/are detected by the method; an operating mode for executing a driving function being able to be ended or blocked, and a transition to a safer operating mode being able to be brought about;

control of the driving function being able to be transferred to the driver, which, in view of the prediction of the future, critical state, is also possible, even though an individual component does not signal a fault or ageing, even in view of the diagnosis. In one embodiment, a state analysis, which includes several components and, therefore, is possibly conducted for the entire vehicle electrical system, is graded higher than a state analysis for only one component or a few components. In addition, in each instance, a driving function is specifically enabled as a function of an operating mode, a cause of failure and/or a topology of the vehicle electrical system. In one embodiment, components, which support a specific driving function and are therefore necessary for its implementation, are taken into account. A decision about enabling a driving function may be made for each driving function, in one embodiment, for an automated driving function. A driving function may take the form of, e.g., a coasting mode during manual travel, but also a coasting mode during automated travel.

A state analysis, in which a plurality of components are considered together, may be used to check the plausibility of a state analysis, in which a smaller number of components are considered together. In this connection, it is checked if results of a state analysis, which report components to a higher-level control unit and/or to the monitoring unit, match results of a state analysis, which result from a system-based analysis of the complete vehicle electrical system. In this context, the vehicle electrical system may be modeled, using, inter alia, nodal and mesh rules, which means that any instances of implausibility may be detected.

Normally, a vehicle electrical system may include components of only one manufacturer or of different manufacturers. In this instance, a component of a first manufacturer may be supplemented and/or replaced by a component of another manufacturer. In this context, it is possible that there is no loading-capacity model and/or ageing model for such a different component, which may be the case, if this component is not intended specifically for use in a motor vehicle. However, in a specific embodiment of the method, this component may also be monitored, and its state may be diagnosed, and the future state may also be predicted. If the vehicle electrical system is made up of components of different manufacturers, then different loading-capacity models of the respective manufacturers may be implemented in the monitoring unit. For example, it is conceivable for the loading-capacity model and the required data for converting the loading to the boundary conditions, at which the loading-capacity model is available, to be stored in each component and, in the case of use in the motor vehicle, to be inputted into the monitoring unit automatically. A loading-capacity model may be ascertained with the aid of trials. Normally, only components, for which the loading-capacity models are available, are used in a highly and/or fully automated motor vehicle.

By communication with the central database, cloud-based changes of an operating mode and/or an operating strategy may be derived via the internet, through exchange of data with the database, in order to reduce malfunctions of the vehicle electrical system. In addition, knowledge of a loading capacity of components of other manufacturers may be ascertained via the internet. If different components of other manufacturers are used in the vehicle electrical system, then possible loading-capacity models and/or ageing models are read in by the monitoring unit. Furthermore, development of the components may be improved by acquiring field data; by acquiring the field data, loading-capacity models being able to be improved, e.g., by deep learning, based on a large number of components, which are monitored in the field. It is also possible for known loading-capacity models to be adjusted and/or updated in view of known, actual loadings of the components.

The method may be used for each motor vehicle, in which enabling of particular driving functions is supposed to be granted as a function of a previous loading, stress and/or ageing of components of the vehicle electrical system, and of the current state of the components. In this context, the method may be used in each motor vehicle, whose electrical system is highly relevant with regard to safety; this relates to, e.g., a motor vehicle, by which a coasting mode or recuperation may be implemented, and/or an automated motor vehicle for performing a highly automated, fully automated, or autonomous operation. During the implementation of an automated driving function, modules, e.g., an engine, a drive unit, a steering system, a brake and/or an electrical brake booster of the motor vehicle, by which a trajectory of the motor vehicle is influenced in the respective vehicle operation, are automatically checked and, therefore, controlled and/or regulated. At least some steps of the method put forward may be carried out by the monitoring unit and/or the control unit in a software-aided manner. To this end, it is also possible to integrate software for implementation in an existing control unit or an existing component of the vehicle electrical system, e.g., a coupling element between channels of the electrical system.

Additional advantages and refinements of the present invention are derived from the description and the appended figures.

It is understood that the features mentioned above and the features still to be explained below may be used not only in the combination specifically indicated, but also in other combinations or individually, without departing from the scope of the present invention.

### BRIEF DESCRIPTION OF THE DRAWING

FIG. 1 shows a schematic representation of an example of an electrical system of a motor vehicle, for which a specific embodiment of the method of the present invention may be implemented, using a specific embodiment of the set-up of the present invention.

FIG. 2 shows a schematic representation of the specific embodiment of the set-up according to the present invention.

FIG. 3 shows a chart for a specific embodiment of the method of the present invention, using the specific embodiment of the set-up of the present invention from FIG. 2.

FIG. 4 shows details regarding operating modes, which may be implemented by the vehicle electrical system within the scope of the specific embodiment of the method.

### DETAILED DESCRIPTION

The present invention is represented schematically in the drawing in light of specific embodiments, and is described below in a detailed manner with reference to the figures.

The figures are described in a cohesive and comprehensive manner, where identical components are assigned the same reference numerals.

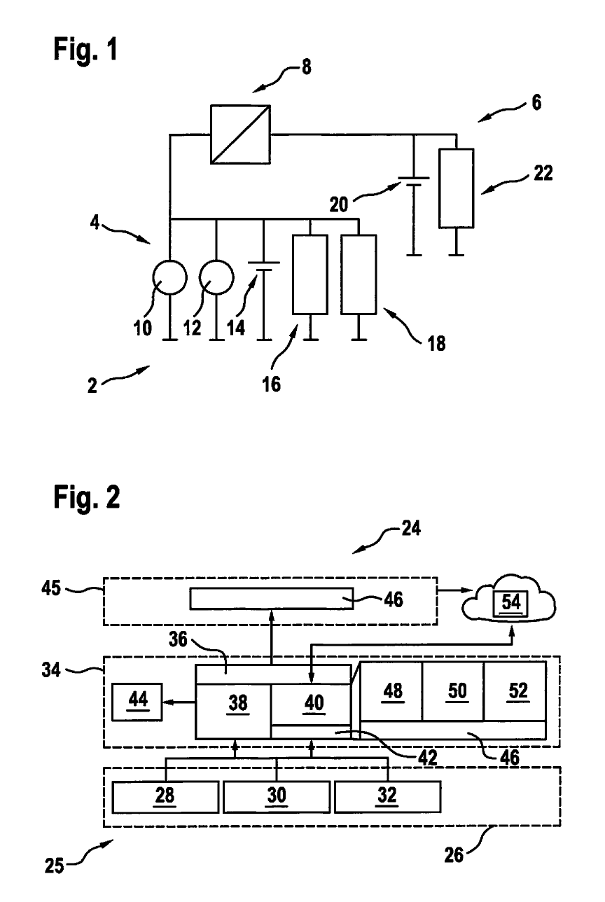

The example of the electrical system 2 for a motor vehicle schematically represented in FIG. 1 includes a first channel 4, which is also referred to as a base electrical system, as well as a second channel 6. In this case, the two channels 4, 6 are interconnected via a d.c. voltage converter 8. First channel 4 of vehicle electrical system 2 includes, as components, a starter 10, a generator 12, a first battery 14, at least one non-safety-related load circuit 16, as well as at least one first safety-related load circuit 18. Second channel 6 includes a second battery 20, as well as at least one second safety-related load circuit 22 as components. In this context, at least one function, which is executed by the at least one first safety-related load circuit 18, may be executed in a redundant manner by the at least one second safety-related load circuit 22. Safety-related load circuits 18, 22 may also be referred to as load circuits critical with regard to safety.

In this case, the two channels 4, 6 have an electrical voltage as an operating variable; here, values of this voltage for the two channels 4, 6 being identical, and, e.g., being 12 volts each. By providing the two channels 4, 6, this vehicle electrical system 2 is constructed redundantly. Using the above-mentioned components of vehicle electrical system 2, it is possible to implement functions for automated travel of the motor vehicle. However, it is also conceivable for the two channels 4, 6 to have different voltages.

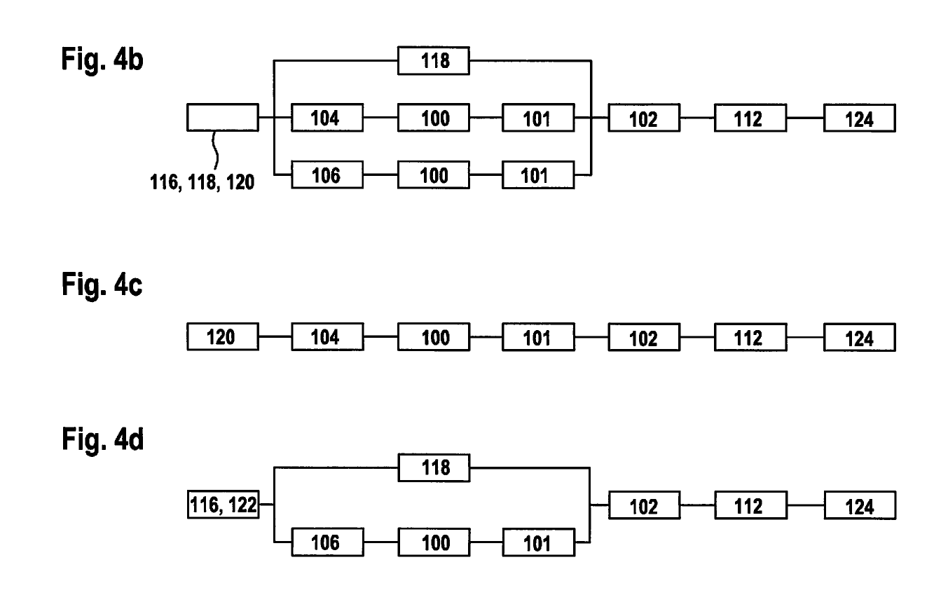

The specific embodiment of the set-up 24 of the present invention schematically represented with the aid of FIG. 2 includes an electrical system 25 for a motor vehicle; this vehicle electrical system 25 including, inter alia, a plurality of load circuits in the form of components 28, 30, 32. Details of this electrical system 25 are derived from FIG. 4. In this context, these components 28, 30, 32 form a component level 26 of vehicle electrical system 25. On a system level 34, vehicle electrical system 25 is assigned a monitoring unit 36, which includes, as components, a module configured as a diagnostic module 38 for making, here, a systemic diagnosis as a state analysis, a module configured as a prediction module 44 for making a prediction in the form of a state analysis, as well as a module configured as a loading-capacity module 42, in which loading-capacity models are stored or, e.g., stored by reading them in. The prediction module is used for ascertaining a loading of components 28, 30, 32 in view of the loading-capacity models from loading-capacity module 42; characteristic quantities for a reliability of components 28, 30, 32 being ascertained. These characteristic reliability quantities are used by prediction module 40 to analyze and predict the state of vehicle electrical system 2, 25. In this context, loading-capacity module 42 includes the loading-capacity models of the components of electrical system 28, 30, 32. In addition, system level 34 includes a module configured as an energy management module 44, which is connected to monitoring unit 36, as well as to components 28, 30, 32. Moreover, a vehicle level 45 of the motor vehicle includes a control unit 46.

In one specific embodiment of the method, using set-up 24, which includes at least monitoring unit 36, components 28, 30, 32 of vehicle electrical system 25 supply monitoring unit 36 with values of physical operating variables, e.g., physical state variables, of components 28, 30, 32, which are ascertained by sensors during operation. In addition, each component 28, 30, 32 may transmit data about their state to monitoring unit 36. Such data are supplemented with values of the physical state variables, which are measured at important locations in vehicle electrical system 25. Furthermore, monitoring unit 36 is also supplied data about a previous loading of at least one specific component 28, 30, 32; the data being based on values of the physical operating variables ascertained up to this point. On the basis of this, decisions regarding an operating mode, a cause of a failure of a component 28, 30, 32, as well as a topology-specific enabling of an automated driving function are made by monitoring unit 36. For each cause of failure and each operating mode possible with the motor vehicle, instances of enabling and exit requests for operating modes and, optionally, further functions, e.g., a prediction for an exchange of a component and a plan for the next regular garage visit, e.g., for a major inspection (MI), are provided for the topology installed in the motor vehicle.

In this case, normal driving 48, recuperation 50, as well as a coasting mode 52 are specified by way of example as operating modes and/or driving functions of the motor vehicle. In this context, coasting mode 52 may be implemented during an automated trip. Using monitoring unit 36, it is decided as a function of a state of at least one component 28, 30, 32 and/or of the entire vehicle electrical system 25, if an automated driving function of the motor vehicle may be enabled or must be prevented, or if a specific operating mode must be exited or may continue to be executed. A respective information item about this is provided to control unit 46 of the motor vehicle. In this instance, data, which are acquired in the specific embodiment of the method, are transmitted wirelessly over the internet to a central, stationary unit 54; this unit 54 being able to take the form of a database and/or garage. In this connection, it is also provided that central unit 54 exchange data with monitoring unit 36.

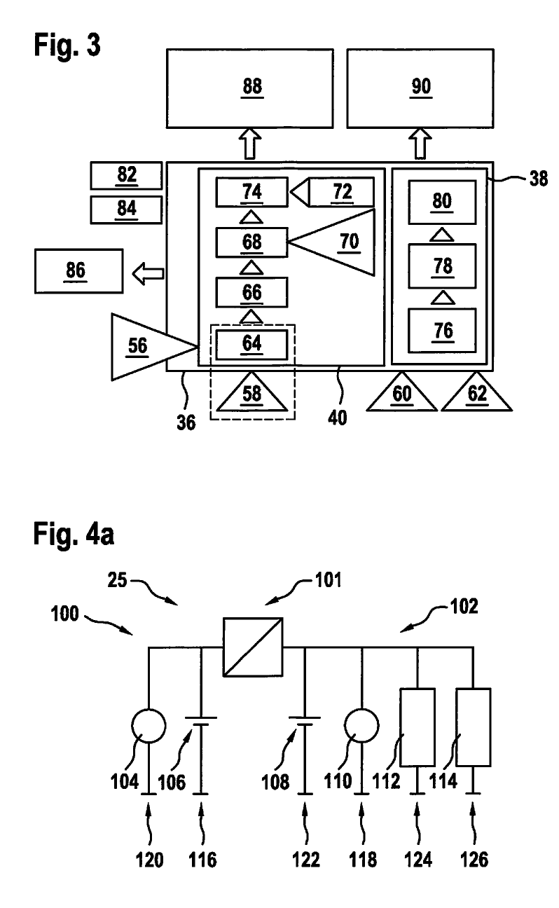

The chart from FIG. 3, which is explained in connection with FIG. 2, shows a possible distribution and a flow of data in monitoring unit 36 during the implementation of a specific embodiment of the method according to the present invention. In this case, monitoring unit 36 makes a prediction, using prediction module 40, and makes a diagnosis, using diagnostic module 38. In so doing, prediction module 40 is supplied external loading-capacity models for components 28, 30, 32 via an interface 56. Alternatively, or in addition, it is possible for the loading-capacity models to be stored in prediction model 40. It is equally conceivable for each component 28, 30, 32 to carry an identification number, with the aid of which a corresponding loading-capacity model may be obtained from the internet.

In addition, a first input 58 is provided, via which monitoring unit 36, in this case, prediction module 40, is supplied loading data of components 28, 30, 32 during continuous operation of vehicle electrical system 25. The loading data are derived from time-dependent characteristics of physical state variables, e.g., the current, the voltage and the temperature. In order to ascertain such characteristics, values of the physical state variables are collected during operation. Data regarding possible faults of components 28, 30, 32 are supplied to diagnostic module 38 by components 28, 30, 32 via a second input 60. Data, in this case, values of physical state variables, e.g., current values of current, voltage and/or temperature, which are generated for components 28, 30, 32 during operation of vehicle electrical system 25, are supplied to diagnostic module 38, and therefore, to monitoring unit 36 as well, via a third input 62. Furthermore, additional physical state variables, such as instantaneous current, voltage and/or temperature values, which are measured at selected locations in vehicle electrical system 25, may be transmitted to diagnostic module 38, and therefore, to monitoring unit 36 as well, via input 62.

Based on the external loading-capacity models, as well as the loading data, loading-capacity models 64 of components 28, 30, 32 are generated by prediction module 40 and stored in prediction model 40. In addition, characteristic reliability quantities of components 28, 30, 32, e.g., a current failure probability of a component 28, 30, 32 based on ageing and/or wear, are ascertained from the loading data of components 28, 30, 32 and loading-capacity models 64. Further loading-capacity models of other manufacturers may be supplied via interface 56. Starting out from here, a probability 66 of a fault of a component 28, 30, 32 due to wear is calculated. In addition, a second probability 68 of an unsafe state of the entire vehicle electrical system 25 is calculated; aspects 70, which relate to an operating mode of the motor vehicle, a cause of a failure, and a topology of electrical system 25, being taken into account. On the basis of the characteristic reliability quantities of components 28, 30, 32, at least one characteristic reliability quantity of vehicle electrical system 25 is calculated for the further aspects 70, and therefore, for each operating mode and each possible cause of failure. Using further aspects 70, a topology of the components 28, 30, 32 installed in the motor vehicle, which has an influence on the at least one characteristic reliability quantity of electrical system 25, is also ascertained. Values of ascertained probabilities 66, 68 are compared to respective limiting values 72 in a comparison element; a risk of a failure of vehicle electrical system 25 being ascertained. In addition, assertions regarding forthcoming exchanges of components 28, 30, 32 are possible, which, in the ideal case, may be carried out within the scope of a regular garage visit.

During a check test 76, states of components 28, 30, 32 are monitored by diagnostic module 38 on the basis of the diagnosis of components 28, 30, 32, which were transmitted via input 60. Using this as a baseline, a system diagnosis 78 is carried out, with the aid of which it is possible to check the plausibility of the diagnoses of components 28, 30, 32 and to identify undetected faults of these components 28, 30, 32. A system diagnosis 78, with the aid of which it is possible to check the states of components 28, 30, 32 for plausibility and to identify undetected faults in vehicle electrical system 25, is carried out, using the values of physical state variables of components 28, 30, 32 transmitted via input 62 and the optionally selected, physical state variables in vehicle electrical system 25. In addition, it is possible to identify faulty components 28, 30, 32. Finally, a status signal 80 regarding a current, actual state of vehicle electrical system 25 is provided; this actual state being ascertained by superposing the diagnosis of components 28, 30, 32, as well as system diagnosis 78 of vehicle electrical system 25.

Calculations 82 are made by monitoring unit 36. In addition, loading capacity models 84 for components 28, 30, 32, as well as for vehicle electrical system 25, are stored in monitoring unit 36 or may be supplied via an interface 56.

In the case of the implementation of the method, there is a first panel 86 for system level 34 and, therefore, for a level of vehicle electrical system 25; the first panel having influencing control over a load management element for protecting components 28, 30, 32 by communication with energy management element 44. A second panel 88 is provided here for motor vehicle level 45. This includes support for enabling and/or an enabling decision for automated driving functions, an increase in reliability via adapted driving strategies, an increase in availability, a safety benefit in the case of a transfer from automated vehicle operation to manual vehicle operation, as well as a requirement to bring the motor vehicle into a safe state during automated vehicle operation, without intervention by the driver, even in the case of a failure of components 28, 30, 32.

In this case, a third panel 90 is provided for future developments. This includes an improvement of loading-capacity models 84, based on a large number of components 28, 30, 32, as well as an improvement of loading-capacity models 84 on the basis of known, actual loadings of components 28, 30, 32.

In the implementation of the specific embodiments of the method, steps for monitoring vehicle electrical system 25 are executed by monitoring unit 36 from the point of view of product safety; a holistic analysis of functional safety, as well as of reliability of components 28, 30, 32 and of vehicle electrical system 25, being carried out. In this context, the at least one component 28, 30, 32, which, in this example, is an energy source, such as generator 10 (FIG. 1), an electrical storage device, such as battery 14, 20, d.c. voltage converter 8 (FIG. 1), an energy distributor, or a load circuit 16, 18, 22 (FIG. 1), transmits values of physical operating variables in the form of characteristic quantities to monitoring unit 36; a diagnosis of the at least one component 28, 30, 32 in the form of a state analysis being derived from the values of the physical operating variables. On the basis of this, on one hand, a physical plausibility check of the diagnoses of components 28, 30, 32 is carried out, which are also transmitted to monitoring unit 36, and on the other hand, a reliability of components 28, 30, 32 and of vehicle electrical system 25 is predicted. The operating variables ascertained in this case are a function of the operating modes possible in the motor vehicle, causes of failure, the utilized topology of vehicle electrical system 25, an operating time of components 28, 30, 32 and their current capacity utilization, the voltage applied to terminals of components 28, 30, 32 and the current flowing through components 28, 30, 32, and, in some instances, a function of further physical state variables, such as the temperature or a state of charge of a battery 14, 20 of components 28, 30, 32, as well as of a status of the diagnosis of components 28, 30, 32.

On the basis of the performed calculations regarding a state of components 28, 30, 32 and of vehicle electrical system 25, monitoring unit 36 transmits a recommendation to control unit 46; the recommendation indicating whether an automated driving function may be enabled or must be prevented. Alternatively, monitoring unit 36 transmits characteristic quantities to control unit 46; the characteristic quantities including information about the state of components 28, 30, 32 and/or of entire vehicle electrical system 25 and/or of parts of it, as a function of the operating mode. In addition to these characteristic quantities, characteristic quantities, which indicate changes of components 28, 30, 32 or a permissible enabling time of the different operating modes, may be considered. In this context, monitoring unit 36 includes two modules, namely, diagnostic module 38 and prediction module 40; monitoring unit 36 being subdivided into these modules.

Using values of the physical operating variables as state variables of components 28, 30, 32 and, optionally, additional physical state variables, which are measured at specific locations in vehicle electrical system 25, electrical system 25 is checked by diagnostic module 38 for the presence of faults. In this context, the values of the operating variables are checked mutually for plausibility and evaluated for performing diagnoses internal to devices and for providing status messages regarding the current state. In this connection, data regarding a topology of vehicle electrical system 2, 25, including components 28, 30, 32 and their configuration, are also considered. In addition, in each instance, a currently active operating mode of the motor vehicle and, therefore, of electrical system 2, 25, as well, is taken into account. In this case, it is possible to monitor individual, e.g., currently active operating modes. In addition, it may also be checked if other operating modes function in a current state. If the motor vehicle is currently being operated in a manual driving mode and the driver would like to change to the automated driving mode, it is checked if vehicle electrical system 2, 25 is in working order to the extent that automated vehicle operation may be enabled. In this connection, an operating mode takes the form of, e.g., start-stop phase, normal driving 48, recuperation 50, or coasting mode 52 with a switched-off engine. The state of vehicle electrical system 2, 25 may be ascertained from data regarding the specific operating mode. In vehicle electrical system 2, 25, different structures are formed as a function of a specific operating mode, since certain components 28, 30, 32 are not active, e.g., generator 12 during coasting mode 52, which means that in the topology, structural differences are formed, which must also be taken into account and, in some instances, give rise to other failure mechanisms.

If, e.g., coasting mode 52 with a switched-off engine is implemented for the motor vehicle, then, in a first example, it is provided that at least one battery 14, 20 (FIG. 1) in the form of a component 28, 30, 32 be discharged within a certain limit, since generator 12 (FIG. 1), as a further component 28, 30, 32, is not driven by the internal combustion engine. However, a negative charge balance of the at least one battery 14, 20 (FIG. 1) produced in this instance is in order.

In a second example, it is provided that generator 12 (FIG. 1) signal faultless operation at a medium capacity utilization, in which case, however, an energy content of first battery 14 (FIG. 1) continuously decreases, which indicates, e.g., a fault of energy management 44, of a control system of generator 12 (FIG. 1), or of first battery 14 (FIG. 1), and/or of a battery sensor of this battery 14. The fault described in light of the second example may not be detected according to today's state of the art, since taken by themselves, each of the components 28, 30, 34 mentioned signal faultless operation. However, from a visual observation of system level 34 in specific embodiments of the method, it is recognized that a totality of status signals, which are, individually, satisfactory on their own, indicates a fault and/or ageing.

If, within the scope of the method, a safety-related fault and/or safety-related ageing, which violate a potential safety objective, are detected by monitoring unit 36, it is provided that a transition to an automated driving function and/or an operating mode, e.g., coasting mode 52 or recuperation 50, not be enabled in the case of automated driving. If the motor vehicle is in a manual driving mode and is intended to be changed into coasting mode 52, but battery 14, 20 has too little energy to restart an engine, then the motor vehicle is not allowed to switch into coasting mode 52. As an alternative to this, it is possible for data about faults and/or ageing with regard to the state of vehicle electrical system 25 to be transferred to control unit 46; execution of an automated driving function being prevented, or an automated driving function possibly being carried out at present being ended at the next opportunity.

Accordingly, results of the diagnosis are used for blocking or enabling automated driving functions; a digital value, e.g., zero or one, being transmitted to control unit 46; the digital value indicating whether a specific, automated driving function is now blocked or enabled. However, it is also possible to provide data about the state of vehicle electrical system 25, using a state variable, which may assume, e.g., values between 0% and 100% and possibly includes specific intermediate steps. On the basis of that, with the aid of control unit 46, an assertion may be made as to how critical the state of vehicle electrical system 25 is quantitatively, so that countermeasures may possibly be taken in stages.

In one alternative or additional specific embodiment, control unit 46 queries automated driving functions designated by monitoring unit 36, e.g., a highway pilot. On the basis of a history of previous values of physical operating variables, which is also based on models 84, monitoring unit 36 ascertains loadings of components 28, 30, 32, which are to be expected in the case of the specific driving function. On this basis, a specific driving function is enabled or prohibited, if the expected loading is too high. If a driving function generates a lower loading, then this may continue to be allowed, and therefore enabled as well.

In the case of the proposed specific embodiment of the method, a prediction of a future state of at least one component 28, 30, 32 and/or of vehicle electrical system 25 is also provided. In this connection, loading data is transmitted from components 28, 30, 32 to prediction module 40. On the basis of such loading data, and of loading-capacity models of components 28, 30, 32, characteristic reliability quantities, such as failure probabilities of components 28, 30, 32, are ascertained. In this context, the loading-capacity models are integrated in prediction module 40. It is also possible to implement loading-capacity models of components of other manufacturers via interface 56.

For each operating mode, the probability that the power supply to safety-related components 28, 30, 32 could be reduced and/or unavailable due to the effects of wear is calculated in prediction module 40. In this context, in each operating mode, several causes of failure may be a reason for the insufficiently available power supply. These are ascertained in a manner corresponding to reliability engineering. Examples of these causes of failure include excessive voltage or low voltage at safety-related components 28, 30, 32, which are each taken into account in separate instances of reliability modeling, since varied reliability-engineering combinations result in the failure of safety-related components 28, 30, 32. Consequently, a calculation of the probabilities is a function of the topology of vehicle electrical system 25, of the operating modes considered, and of the causes of failure. In order to calculate this probability, a reliability block diagram, e.g., a fault tree, a Markov model, or the like, is stored for each operating mode, e.g., for automated driving, automated driving with coasting, automated driving with recuperation, normal driving, etc., in combination with every possible cause of failure; the reliability block diagram being populated with data and computed, using currently calculated failure rates of components 28, 30, 32. The reliability block diagram or a comparable method for modeling the system reliability supplies the criticality of a fault, ageing and/or wear of components 28, 30, 32 of the entire vehicle electrical system 25.

In the modeling of the reliability block diagram or the alternative method, it is taken into account that its structure is not oriented to the electrical circuit diagram of vehicle electrical system 25, but to a combination of faults or ageing, which, based on the cause of failure, result in a supply of power having voltage values that are less than a predefined minimum value or greater than a predefined maximum value and lead outside of a predefined voltage interval through the safety-related load circuits.

In the scope of the specific embodiment of the method, it is possible, in the case of a third example, for d.c. voltage converter 8 (FIG. 1) to fail as a component 28, 30, 32 of vehicle electrical system 25; it being a critical state, since due to the failure of d.c. voltage converter 8, battery 20 is automatically discharged, which results in low voltage in second channel 6 as a cause of failure. This failure is taken into account by modelling of reliability.

In a fourth example, first battery 14 (FIG. 1) in first channel 4 (FIG. 1) fails. If coasting mode 52, in which generator 12 (FIG. 1) is switched off and a lower amount of electrical energy is consequently generated, is also set as a driving function for the motor vehicle, then a low voltage may result as a cause of failure. This is also taken into account in the reliability block diagram. The conditional probabilities 74 ascertained in this case are compared to limiting values 72. In this context, due to the systemic diagnosis of the actual state of vehicle electrical system 25, a driving function critical with regard to safety is only enabled if the actual state of electrical system 25 is satisfactory. In this case, the conditional probability, which includes a probability of a state of vehicle electrical system 25 critical with regard to safety, under the assumption of an operative actual state, may also be ascertained. In this instance, monitoring unit 36 signals, to control unit 46, the operating modes that may and may not be enabled during the execution of an automated driving function; an automated driving function also being able to be prevented completely and, therefore, eliminated.

Within the scope of the method, further, optional measures for optimization may also be taken. If set-up 24 is configured as a self-learning system, it is possible to adapt a specific operating strategy to a loading response, which means that components 28, 30, 32 may be used in an optimum manner. In addition, monitoring unit 36 may exchange data with central unit 54. In this manner, inter alia, realistic driving profiles for future developments and/or designs of vehicle electrical systems 25 may be provided. Furthermore, loading-capacity models may be improved by evaluating field data of identical components of a plurality of motor vehicles. It is also possible to adapt, that is, to modify and/or to supplement, loading-capacity models already available. In addition, it is possible to communicate with central device 54 in an automated manner. If a limited service life is predicted for a component 28, 30, 32, it is possible, inter alia, to replace the respective, affected component 28, 30, 32 in a timely manner. It is likewise possible to predict the loading in view of a route profile, using navigation data.

The vehicle electrical system 25 schematically represented in FIG. 4a in a detailed manner also includes a first channel 100 and a second channel 102, which are connected by a d.c. voltage converter 101 as a possible component 28, 30, 32 (FIG. 2) of electrical system 25. First channel 100 includes a generator 104 and a first battery 106 as components 28, 30, 32 (FIG. 2). Second channel 102 includes a second battery 108, a starter 110, a first safety-related load circuit 112, as well as a second non-safety-related load circuit 114 as components 28, 30, 32 (FIG. 2). Furthermore, FIG. 4 shows a first ground-potential point 116, a second ground-potential point 118, a third ground-potential point 120, a fourth ground-potential point 122, a fifth ground-potential point 124 and a sixth ground-potential point 126 of vehicle electrical system 25. Some of these above-mentioned components 28, 30, 32, 100, 101, 102, 104, 106, 108, 110, 112, 114, 116, 118, 120, 122, 124, 126 of vehicle electrical system 25 are also shown schematically in flow charts of FIGS. 4b, 4c and 4d; in this connection, components 28, 30, 32, 100, 101, 102, 104, 106, 108, 110, 112, 114, 116, 118, 120, 122, 124, 126 being connected logically in series and/or in parallel.

In the specific embodiment of the method, normal driving 48, recuperation 50, as well as coasting mode 52 may be implemented as a driving function for vehicle electrical system 25 and, therefore, for its components 28, 30, 32 (FIG. 2).

During execution of normal driving 48 (FIG. 2), mechanical energy, which is generated when the engine of the motor vehicle is running, is converted by generator 104 to electrical energy that is supplied to the two batteries 106, 108, in which case these are charged. In addition, safety-related load circuit 112 and non-safety-related load circuit 114 are also supplied power during normal driving 48. As the flow chart from FIG. 4b shows for this, starting from at least one ground-potential point 116, 118, 120, electrical energy is transported by generator 104 or first battery 106, via first channel 100, d.c. voltage converter 101 and second channel 102, to safety-related load circuit 112 and ground-potential point 124.

During recuperation 50, the mechanical energy from motion of the motor vehicle is converted by generator 104 to electrical energy, which, in this case, is likewise supplied to the two batteries 106, 108, as well as to safety-related load circuit 112 and to the non-safety-related load circuit. To this end, the flow chart from FIG. 4c shows that, starting from at least ground-potential point 120, electrical energy is transported by generator 104, via first channel 100, d.c. voltage converter 101 and second channel 102, to safety-related load circuit 112 and ground-potential point 124.

In coasting mode 52 (FIG. 2), it is provided, however, that generator 104 be deactivated. In coasting mode 52 (FIG. 2), electrical energy for powering safety-related load circuit 112 is supplied to it from the two batteries 106, 108. In light of the above-mentioned operating modes, the reasons, for which different models of vehicle electrical system 25 are utilized for the state analysis for each operating mode, are shown by way of example. To this end, the flow chart from FIG. 4c shows that, starting from at least one ground-potential point 116, 120, electrical energy is transported by first battery 106, via first channel 100, d.c. voltage converter 101 and second channel 102, to safety-related load circuit 112 and ground-potential point 124.

The method for state analysis and, therefore, for diagnosing the current state and/or for predicting the future state is executable for all components 28, 30, 32 of vehicle electrical system 2, 25, which are configured for providing electrical energy. Thus, it is possible to supply safety-related load circuits 112 with electrical energy within a predefined interval for values of the at least one physical, in this case, the at least one electrical operating variable. In this context, this interval is determined by a minimum value, and therefore, an upper limit, as well as by a maximum value, and therefore, a lower limit. This relates to, in each instance, an upper and a lower limit for a voltage and/or a current as a physical operating variable. In this context, such limits and/or non-safety-related load circuits 114 may optionally be considered as needed in the respective state analysis.

Within the scope of the state analysis taking the form of a diagnosis, a diagnosis of at least one component 28, 30, 32 is checked for plausibility, using a diagnosis of all of the components 28, 30, 32 and, therefore, of entire vehicle electrical system 25 as a system; faults of individual components 28, 30, 32 not discovered up to now being able to be detected, since components 28, 30, 32 are diagnosed not individually, but comprehensively over the system; mutual interaction of components 28, 30, 32 being able to be taken into account. Accordingly, the diagnosis on component level 26 is checked for plausibility, using the diagnosis on system level 34. Thus, in one embodiment, it is possible for an individual, faulty component 28, 30, 32 to be able to be identified possibly as not faulty during the making of an individual diagnosis, whereas an effect of this faulty component 28, 30, 32 on at least one further component 28, 30, 32 may be identified during the system-spanning diagnosis.

In addition, results of individual diagnoses, where a diagnosis for each component 28, 30, 32 is made individually on the component level 26, are combined centrally in monitoring unit 36. During the diagnosis on system level 34, at least the at least one physical operating variable and, optionally, characteristic quantities, likewise, at least the at least one physical operating variable of entire vehicle electrical system 25, are ascertained and/or measured as characteristic quantities of components 28, 30, 32.

Within the scope of the state analysis taking the form of a prediction, loading-related, characteristic quantities, inter alia, loading-related, physical operating variables, are measured and stored for the at least one component 28, 30, 32 during operation, and therefore, also written to a storage device of monitoring unit 36, which is configured to store data. The measured values are converted to a defined level of loading. In the case of a subsequent comparison with the loading capacity of components 28, 30, 32, failure probabilities of components 28, 30, 32 are ascertained. From this, a failure probability of vehicle electrical system 25, which is a function of an operating mode and/or a cause of failure, may be calculated, e.g., in view of a topology of electrical system 25, as well; inter alia, a layout of components 28, 30, 32 and their connections among each other and/or their distribution to channels 100, 102 being able to be considered along with the topology. By extrapolating the previous loading of components 28, 30, 32, a component-level 26 prediction of individual components 28, 30, 32, as a rule, of at least one component 28, 30, 32 may be made, and a system-level 34 prediction of entire vehicle electrical system 25, and therefore, for all of the components 28, 30, 32, may be made.

In addition, the state analysis taking the form of a prediction, for individual components 28, 30, 32 on component level 26, may be checked for plausibility, using the prediction of entire vehicle electrical system 25 on system level 34, as in the case of the state analysis taking the form of a diagnosis. In the case of the prediction taking the form of a state analysis, the logged data regarding the loading-related, characteristic quantities are processed and both acquired and stored with loading-related, characteristic quantities, inter alia, loading-related, physical operating variables, and therefore, written to a storage device of monitoring unit 36, which is configured to store data. These data are compared to loading-capacity models of components 28, 30, 32, out of which current characteristic reliability quantities may be ascertained. In this connection, it is possible, in one embodiment, for the characteristic reliability quantities to be ascertained by mapping the reliability structure of the operating modes as a function of relevant failure mechanisms. By extrapolating the loading up to now, a reliability prediction may be made on component level 26 and on system level 34, which may be checked mutually for plausibility. A prediction of the future state may be made from the previous loading and the stored loading-capacity model.

In a further refinement, it is possible to check the plausibility of at least one state analysis taking the form of a diagnosis, that is, a diagnosis on system level 34 and/or a diagnosis on component level 26, using at least one state analysis taking the form of a prediction, that is, a prediction on system level 34 and/or a prediction on component level 26, and vice versa. If, e.g., an automated driving function could now be implemented on the basis of the at least one diagnosis of the current, actual state of the at least one component 28, 30, 32, this would be able to be prevented on the basis of the at least one prediction of the future state of the at least one component 28, 30, 32, since in the case of the at least one prediction, as a rule, a greater number of values of operating variables is taken into account than in the case of the at least one diagnosis.

The state analyses for the diagnosis and the prediction may be carried out online and/or during continuous operation of electrical system 2, 25 and of the motor vehicle.

1.-12. (canceled)

13. A method for operating a vehicle electrical system of a motor vehicle, the vehicle electrical system including a plurality of components, the method comprising:
determining a prediction of a future state of at least one component, the prediction being made in the form of a state analysis from values regarding a loading capacity of the at least one component;
determining a decision about enabling at least one driving function of the motor vehicle as a function of a result of the state analyses carried out;
supporting the driving function by the at least one component of the vehicle electrical system.

14. The method as recited in claim 13, further comprising:
determining a decision about enabling an automated driving function of the motor vehicle is made.

15. The method as recited in claim 13, wherein the at least one component of the vehicle electrical system supplies electrical energy.

16. The method as recited in claim 13, further comprising:
storing measured values of physical operating variables of the at least one component of the vehicle electrical system, wherein a previous loading and at least one loading capacity of the at least one component is ascertained from the measured values.

17. The method as recited in claim 16, wherein a loading-capacity model for the at least one component is ascertained in view of a current loading.

18. The method as recited in claim 17, wherein a characteristic reliability quantity for the at least one component is ascertained from the loading-capacity model.

19. The method as recited in claim 16, wherein:
at least one of at least one previous fault of the at least one component, at least one previous failure of the at least one component, a previous instance of wear of the at least one component, an ageing of the at least one component, an operating mode of the at least one component, and a topology of the vehicle electrical system is considered as the previous loading of the at least one component.

20. The method as recited in claim 17, wherein in order to ascertain the loading-capacity model for the at least one component, a loading of at least one identical component, which is situated outside of the motor vehicle, is taken into account.

21. The method as recited in claim 19, wherein:
a reliability analysis is conducted for each of the plurality of components,
the reliability analysis is performed for one of the entirety of the vehicle electrical system and at least one part corresponding to at least one channel of the entirety of the vehicle electrical system,
the reliability analysis is carried out by mapping a layout of the vehicle electrical system from a topology of the vehicle electrical system, and in view of a cause of a failure, and in view of an operating mode, and
with the aid of the reliability analysis involving a comparison with a limiting value, a decision about the enabling is made.

22. The method as recited in claim 13, wherein:
a diagnosis of an actual state is carried out from values of physical operating variables of all of the components, in the form of a first, additional state analysis of all of the components of the vehicle electrical system,
a diagnosis of an actual state is made from values of physical operating variables of, in each instance, one component, in the form of at least one second, additional state analysis for, in each instance, one component alone, and
the at least one second, additional state analysis for, in each instance, one component is checked for plausibility, using the first additional state analysis for all of the components.

23. A set-up for operating a vehicle electrical system of a motor vehicle in which the vehicle electrical includes a plurality of components, comprising:
a monitoring unit having a prediction module configured to make a prediction of a future state of at least one component from values regarding a loading capacity of the at least one component in the form of a state analysis; and
a prediction module configured to decide about enabling at least one driving function of the motor vehicle as a function of a result of the conducted state analyses, wherein the driving function is supported by the at least one component of the vehicle electrical system.

24. The set-up as recited in claim 23, wherein the at least one driving function is an automated driving function, the set-up further comprising:
a control unit for executing the automated driving function, wherein the monitoring unit provides the control unit a recommendation as to whether one of the automated driving function is enabled, the automated driving function is to be prevented, and the automated driving function is to be exited.
